(19) United States
(12) Patent Application Publication
(10) Pub. No.: US 2010/0216955 A1
(43) Pub. Date: Aug. 26, 2010

(54) METHOD OF PRODUCING HIGHLY TRANSPARENT POLYPROPYLENE INCLUDING PREPOLYMERIZATION STEP

(75) Inventors: Nan-young Lee, Seoul (KR); Churl-young Park, Daejeon (KR); Jin-woo Lee, Daejeon (KR); Ro-my Lee, Daejeon (KR); Dong-ryul Im, Daejeon (KR)

Correspondence Address: LGCHEM;Lerner, David, Littenberg, Krumholz & Mentlik, LLP, 600 South Avenue West, Westfield, NJ, 07090, US

(73) Assignee: LG CHEM, LTD., Seoul (KR)

(21) Appl. No.: 12/680,617

(22) PCT Filed: Oct. 1, 2008
(86) PCT No.: PCT/KR08/05775

§ 371 Date: Mar. 29, 2010

(30) Foreign Application Priority Data
Oct. 2, 2007 (KR) 10-2007-0099220

(51) Int. Cl. C08F 4/64; C08F 4/52

(52) U.S. Cl. 526/123.1; 526/226

(57) ABSTRACT

Disclosed is a method of preparing a highly transparent polypropylene comprising a step of prepolymerizing an α-olefin and a vinyl cyclic saturated hydrocarbon in the presence of a Zegler-Natta catalyst and an external electron donor, wherein a step of adding and prepolymerizing the α-olefin is followed by a step of adding and prepolymerizing the vinyl cyclic saturated hydrocarbon. The method provides polypropylene having superior tacticity and transparency with not decreasing the activity of the polymerization catalyst at the polymerization of propylene.

### TECHNICAL FIELD

The present invention relates to a method of preparing a highly transparent polypropylene comprising an olefin prepolymerization step, and more precisely, a method for preparing polypropylene with improved tacticity and transparency and without decreasing the activity of a polymerization catalyst at the polymerization of propylene.

### BACKGROUND ART

A propylene polymer has good moldability and mechanical strength and also is cheap, so it has been used in various fields, however its improvement in rigidity and transparency and high cycle injection moldability of injection molding without damaging intrinsic properties of the propylene polymer are required. These properties are known to be improved by increasing the crystallization speed of the propylene polymer.

Conventionally a lot of nucleating agents by which a crystallization speed can be enhanced, have been proposed. Aluminum salts of an aromatic carboxylic acid, and a substituted or an unsubstituted divenzylidene sorbitol have come into the market.

The above nucleating agent enhances the crystallization speed of polypropylene in the step of melting, cooling and solidifying of polypropylene. A spherical crystal of polypropylene is finally prepared into the form of minute particles. The nucleating agent also improves a transparency, gloss and rigidity and reduces cycle time for moldability of the final polypropylene products. However, this nucleating agent has problems that an anisotropic shrinking rate is occurred or the agent is attached on a die, a mold or a roll to occur an inferior bending of the product.

Recently, researches were disclosed that prepolymerization process of a vinyl compound is performed prior to polymerization process to improve rigidity and transparency. For example, Japanese patent publication No. 60-139710 discloses a method of prepolymerizing a very small amount of vinyl cycloalkane prior to the polymerization of propylene. Because a polymer of the vinyl cycloalkane has a melting point of about 370° C., higher than that of polypropylene (m.p. of a pure isotactic polypropylene: 176° C.), the vinyl cycloalkane can be used as a nucleating agent. However, the volume density of a polypropylene powder obtained is largely decreased and has a low productivity and also the polymerization reactivity of the vinyl cyclic saturated hydrocarbons is much lower than that of polypropylene. In order to increase the polymerization speed, the polymerization is carried out at high temperature however causing a problem of decreasing activity of a polymerization catalyst in the polymerization of propylene.

As another exemplary method, there is a method which an external electron donor compound is added at prepolymerization of a vinyl cyclic saturated hydrocarbon to improve the tacticity of polypropylene. However, this technique has a problem of decrease polymerization reactivity of the vinyl cyclic saturated hydrocarbon.

In addition, as another of exemplary method, Japanese patent publication No. Hei 04-096907 discloses a method of prepolymerizing polypropylene for high transparent polypropylene wherein a multistage prepolymerization of propylene is performed in the presence of a titanium compound, organic aluminum impound and an organic silicon impound and other organic silicon (impound is used in the each prepolymerization step and also vinyl cyclic saturated hydrocarbon and styrene impound are polymerized in at least one of prepolymerization steps. However, this method has also a problem of decreasing activity of a polymerization catalyst in the polymerization of propylene.

Accordingly, a method of preparing polypropylene having improved rigidity, transparency, moldability and tacticity without decreasing the activity of a polymerization catalyst at the polymerization of propylene is required.

### DISCLOSURE OF INVENTION

### Technical Problem

It is an object of the present invention to provide a method of polymerizing propylene having improved tacticity and transparency without decreasing the activity of a polymerization catalyst at the polymerization of propylene.

The above object and other objects of the present invention can be achieved with the following embodiments of the present invention.

### Technical Solution

To achieve the above object, the present invention provides a method of preparing a highly transparent polypropylene comprising a step of prepolymerizing an α-olefin and a vinyl cyclic saturated hydrocarbon in the presence of Ziegler-Natta catalyst and an external electron donor, wherein a step of adding and prepolymerizing the α-olefin is followed by a step of adding and prepolymerizing the vinyl cyclic saturated hydrocarbon.

Hereinafter, the present invention is described in detail.

These inventors confirmed that a method of preparing polypropylene comprising the step of prepolymerizing an α-olefin and a vinyl cyclic saturated hydrocarbon in the presence of Ziegler-Natta catalyst, wherein a step of adding and prepolymerizing the α-olefin is followed by a step of adding and prepolymerizing the vinyl cyclic saturated hydrocarbon and an external electron donor is added before the prepolymerization is capable of manufacturing polypropylene having superior tacticity and transparency without decreasing the activity of a polymerization catalyst at the polymerization of propylene and they complete the present invention based on the above fact.

A method of preparing a highly transparent polypropylene according to the present invention is characterized in that this method comprises a step of prepolymerizing an α-olefin and a vinyl cyclic saturated hydrocarbon in the presence of a Ziegler-Natta catalyst and an external electron donor, and a step of adding and prepolymerizing the α-olefin is followed by a step of adding and prepolymerizing the vinyl cyclic saturated hydrocarbon.

The Ziegler-Natta catalyst is dispersed uniformly in non-polar solvent at the prepolymerization and polymer chain is grown by the polymerization of monomer at the surface of the catalyst and a prepolymer of which one ends in a polymer chain are coupled with is finally obtained.

The Ziegler-Natta catalyst includes any catalysts for polymerizing olefin without limit but is preferred to use a product prepared by using a transition metal compound comprising elements of family 4, family 5 or family 6 of the periodic table; and an organic metal compound comprising elements of family 13 of the periodic table.

The transition metal compound may be used as a main catalyst in the Ziegler-Natta catalyst, and may be solid titanium catalyst containing magnesium, titanium, a halogen element and an internal electron donor.

The internal electron donor may be diether compounds, phthalate compound or a mixture. A preferred example is diisobutylphthalate.

The organic metal compound is used as a co-catalyst in a Ziegler-Natta catalyst and preferably may be an organic aluminum compound. Preferred examples are a trialkyl aluminum, a dialkyl aluminum halide, an alkyl aluminum dihalide, an aluminum dialkyl hydride, an alkyl aluminum sesquihalide, and a mixture thereof. More preferred examples are Al(C₂H₅)₃, Al(C₂H₅)₂H, Al(C3H7)3, Al(C₃H₇)₂H, Al(i-C₄H₉)₂H, Al(C₈H₁₇)₃, Al(C₁₂H₂₅)₃, Al(C₂H₅)(C₁₂H₂₅)₂, Al(i-C₄H₉)(C₁₂H₂₅)₂, Al(i-C₄H₉)₃, (C₂H₅)₂AlCl, (i-C₃H₇)₂AlCl, (C₂H₅)₃Al₂Cl₃ or a mixture thereof containing at least two compounds.

The mixture thereof may be a mixture of Al(C₂H₅)₃ and Al(i-C₄H ₉)₃; a mixture of Al(C₂H₅)₃ and Al(C₈H₁₇)₃; a mixture of Al(C₄H₉)₂H and Al(C₈H₁₇)₃; a mixture of Al(i-C₄H₉)₃ and Al(C₈H₁₇)₃; a mixture of Al(C₂H₅)₃ and Al(C₁₂H₂₅)₃; a mixture of Al(i-C₄H₉)₃ and Al(C₁₂H₂₅)₃; a mixture of Al(C₂H₅)₃ and Al(C₁₆H₃₃)₃; and a mixture of Al(C₃H₇)₃ and Al(C₁₈H₃₇)₂(i-C₄H₉).

The Ziegler-Natta catalyst consists of a transition metal compound as a main catalyst and an organic metal compound as a co-catalyst. Preferably, the molar ratio of the organic metal compound to the transition metal compound is 5-50 (if the transition metal impound is used in an amount of 1 mol, the organic metal impound is preferably used in an amount of 5-50 mols).

The external electron donor considerably affects a crystallization temperature, tacticity and melt flow index of the final product polypropylene. The external electron donor preferably comprises one or more functional group selected from the group consisting of substituted or unsubstituted alkyl having 1 to 20 carbon atoms, substituted or unsubstituted aryl having 6 to 30 carbon atoms, substituted or unsubstituted cycloalkyl having 5 to 30 carbon atoms, and substituted or unsubstituted alkoxy group having 1 to 20 carbon atoms; and an organic silane impound having at least one oxygen atoms. A preferable example may be an aliphatic organic silane compound such as diphenyldimethoxysilane, phenyltrimethoxysilane, phenylethyldimethoxysilane, phenylmethyldimethoxysilane, trimethylmethoxysilane, isobutyltrimethoxysilane, diisobutyldimethoxysilane, diisopropyldimethoxysilane, di-t-butyldimethoxysilane, dicyclopentyldimethoxysilane, cyclohexylmethyldimethoxysilane, dicyclohexyldimethoxysilane, and a mixture thereof.

The external electron donor is preferably added prior to a prepolymerization. If the external electron donor is added while prepolymerization, the activity of the polymerization catalyst is decreased in the polymerization of propylene and polypropylene having low tacticity and transparency is obtained.

The molar ratio of the external electron donor to a transition metal compound is up to 50 and preferably 0.1-10. The molar ratio in the above range increases an activity of the polymerization catalyst according to the amount added of he external electron donor; however if the molar ratio is above 10, an activity and a transparency of the polymerization catalyst are decreased largely.

An α-olefin added at the prepolymerization process may be propylene and the α-olefin is added to the prepolymerization process at 0.5-100 g/g Ziegler-Natta catalyst (containing 0.50 mmol of titanium), and preferably 0.5-20 g. Also the α-olefin may be added at 0.02-6 g/h.

The vinyl cyclic saturated hydrocarbon may be a vinyl cyclic saturated hydrocarbon having 5 to 10 carbon atoms such as vinyl cyclobutane, vinyl cyclopentane, vinyl cyclohexane, vinyl-3-methylcyclopentane, vinyl-2-methylcyclohexane, vinyl-3-methylcyclohexane. More preferably the vinyl cyclic saturated hydrocarbon may be vinyl cyclobutane.

The vinyl cyclic saturated hydrocarbon is added at 10-30 g/g Ziegler-Natta catalyst (containing 0.50 mmol of titanium) and preferably 10-15 g. This range gives excellent activity and transparency.

It is preferable that a step of adding and prepolymerizing an α-olefin is followed by a step of adding and prepolymerizing a vinyl cyclic saturated hydrocarbon.

Adding and prepolymerizing an α-olefin first has an effect of α-olefin polymer being coated on the Ziegler-Natta catalyst, thereby preventing the catalyst particles from breaking at the prepolymerization of vinyl cyclic saturated hydrocarbon. In addition, uniform prepolymer particles can be obtained and the morphology of the polypropylene prepared at the polymerization may be improved.

At the prepolymerization, other monomer may be included other than α-olefin and vinyl cyclic saturated hydrocarbon.

The non-polar solvent used for the prepolymerization may be alkane compounds such as hexane, n-heptane, octane, nonane and decane; and cycloalkane aromatic compounds. Among those (impounds, hexane is preferred and is more preferably purified hexane so as not to affect the activity of the catalyst.

The prepolymerization may be carried out at −10-50° C. and 0.1-10 bar for 0.5-50 hours, and preferably 0-40° C. and 0.1-2 bar for 1-10 hours.

The prepolymer catalyst (one ends of polymer chain prepared by the Ziegler-Natta catalyst, the α-olefin and vinyl cyclic saturated hydrocarbon are coupled with) prepared through the prepolymerization may be 8-20 g (except the amount of Ziegler-Natta catalyst)/1 g of the Ziegler-Natta catalyst. Within the above range, the activity of the catalyst can be maintained high and the transparency thereof can be improved.

Afterward, the polymerization of propylene may be performed in the presence of the prepolymer obtained by the prepolymerization.

The polymerization of propylene can be carried out by the any methods using the conventional Ziegler-Natta catalyst without limitation.

Preferably, the polymerization of propylene may be carried out in the condition that oxygen and water are eliminated.

The polymerization of propylene may be carried out at 20-200° C. and preferably 50 to 180° C.; at 1-100 atm and preferably 2-50 atm.

A polypropylene prepared by the polymerization has a tacticity of 99±1%.

The melt flow rate (230° C., 2.16 kg) of the polypropylene prepared by the polymerization is 4±2 g/10 minutes.

The polymerization of propylene may be ∞-polymerization of an alpha-olefin such as ethylene, 1-butene and 1-hexene with the propylene.

### BEST MODE FOR CARRYING OUT THE INVENTION

Practical and presently preferred embodiments of the present invention are illustrated as shown in the following examples.

However, it will be appreciated that those skilled in the art, on consideration of this disclosure, may make modifications and improvements within the spirit and scope of the present invention.

### EXAMPLE

### Example 1

### <Preparation of Magnesium-titanium Catalyst>

To a glass reactor of 500 ml in the atmosphere of nitrogen at 0° C. were added 25.25 g of MgCl₂·2.8C₂H₅OH and 150 ml of heptane anhydride and stirred, and 21.6 ml of 1M diisobutylphtalate was added and stirred for 10 minutes. And then 100 ml (0.91 mol) of TiCl₄ was added at 0° C. and reacted at room temperature for 1 hour. Further, 150 ml (1.36 mol) of TiCl₄ was added, the temperature was raised to 100° C. and the mixture was reacted for 2 hours. The supernatant was separated out and 200 ml (1.82 mole) of TiCl₄ was added at 0° C. The temperature was raised to 120° C. and the reactant was reacted for 2 hours. Upon the completion of the reaction, an solid magnesium-titanium catalyst obtained after filtering was washed with heptane six times and vacuum-dried at 40° C. for 2 hours to prepare a final product, magnesium-titanium catalyst (containing 2.4 weight % of titanium)

### <Preparation of Prepolymer>

A 0.5 l reactor was purged with argon at high temperature. To the reactor were added 2 g (titanium 1.0 mmol) of the catalyst obtained above, 200 ml of hexane, 8.75 mmol of triisobutylaluminum, 1.75 mmol of trimethylmethoxysilane (TMMS). The propylene concentration was adjusted to 18 cc/min. Prepolymerization was performed at 20° C. for one hour. Then, 20 g of cyclohexane(VCH) was added and prepolymerization was performed again at 20° C. for three hours. Upon impletion of the prepolymerization, the reactant was washed with hexane three times to finally obtain prepolymer slurry (A dried prepolymer obtained by vacuum-drying at room temperature for 2 hours is 11.6 g/1 g of Ziegler-Natta catalyst). The content of polymer in the prepolymer prepared through prepolymerization except the Ziegler-Natta catalyst component was 10.6 g per 1 g of the Ziegler-Natta catalyst.

### <Preparation of Polypropylene (Polymerization)>

A 2 l autoclave reactor was vacuum-dried for one hour, followed by purging with nitrogen. To the reactor were added 4 nmol of triethyl aluminum, 0.4 mmol of dicyclopentyldimethoxysilane and the prepolymer slurry (containing 0.5 mmol of titanium). To the reactor were added hydrogen to 40 bar and subsequently 1.2 l of liquid propylene, followed by adding ethylene in the amount of 300 cc/min for 1 hour while stirring. The reaction temperature was raised to 70° C. and polymerization was performed for one hour. Upon impletion of the polymerization reaction, non-reacted gas was emitted and the temperature was cooled to room temperature to terminate the reaction. The produced polymer was separated to collect and dried for one hour in a 70° C. vacuum oven to prepare a white polypropylene.

### Example 2

A polypropylene was prepared in the same manner as described in Example 1, except that 2.63 mmol of trimethylmethoxysilane was added to prepare a prepolymer.

### Example 3

A polypropylene was prepared in the same manner as described in Example 1, except that 4.38 mmol of trimethylmethoxysilane was added to prepare a prepolymer.

### Example 4

A polypropylene was prepared in the same manner as described in Example 1, except that 1.75 mmol of triethylmethoxysilane(TMES) was added to prepare a prepolymer.

### Comparative Example 1

A polypropylene was prepared in the same manner as described in Example 1, except that the polymerization of propylene was carried out by adding 10 mg of magnesium-titanium catalyst (containing 0.5 mmol of titanium) without the prepolymerization step.

### Comparative Example 2

A polypropylene was prepared in the same manner as described in Example 1, except that the polymerization of propylene was carried out by adding 30 g of vinyl cyclohexane and reacting for 7 hours without adding an external electron donor to prepare a prepolymer.

### Comparative Example 3

A 0.5 l reactor was purged with argon at high temperature. To the reactor were added 2 g of the magnesium-titanium catalyst obtained in the Example 1 (titanium 1.0 mmol), 200 ml of hexane, 8.75 mmol of triisobutylaluminum. The propylene concentration was adjusted to 18 cc/min. Prepolymerization was performed at 20° C. for one hour and 20 minutes. Then 20 g of vinyl cyclohexane was added and prepolymerization was performed again at 20° C. for three hours. 1.75 mmol of trimethylmethoxysilane, 8.75 mmol of triisobutylaluminum were added and the prepolymerization was performed again for 15 minutes with adjusting 150 cc/min of propylene concentration. Upon completion of the prepolymerization, a solid prepolymer was obtained after filtering and prepolymer slurry was prepared by washing the solid prepolymer with hexane three times (the amount of the prepolymer after vacuum-drying at room temperature for 2 hours is 11 g per 1 g of the Ziegler-Natta catalyst). The amount of polymer except for the Ziegler-Natta catalyst among the prepared prepolymer is 9.5 g per 1 g of the Ziegler-Natta catalyst. The polymerization of propylene was performed in the same manner as described in Example 1.

### Experimental Example

The properties of the prepolymer and the polypropylene prepared in the above

Examples 1 to 4 and Comparative examples 1 to 3 are examined as follows and the results were shown in the following table 1.

(1) Activity

The polymerization activity of a catalyst (kg PP/g catalyst) is measured by the weight ratio of the produced polymer (kg) to the catalyst used (g catalyst).

(2) Melt Flow Rate

Melt flow rate is measured by ASTM D1238 at 230° C. by using a 2.16 kg weight, and is presented as the weight of a polymer (g) melted for 10 minutes (g/10 min.).

(3) Tacticity

Tacticity of the polymer (%) is a ratio of the weight of a non-extracted polymer in o-xylene after boiling for one hour. The tacticity is measured by the following process.

First, 200 ml of o-xylene was added to a flask, followed by filtering with an extract paper (200 mm, No.4). An aluminum pan was dried for 30 minutes in an oven at 150° C., followed by cooling in a desiccator and a weight measurement was performed. 100 ml of the filtered o-xylene was added on the aluminum pan by using a pipette. The aluminum pan containing the o-xylene was heated at 145-150° C. to evaporate all of the o-xylene. Then, the aluminum pan was vacuum-dried at 100±5° C. for 1 hour at a pressure up to 13.3 kPa. The aluminum pan was then cooled in the desiccator and the weight was measured twice (Error was less than 0.0002 g), indicating that blank test of o-xylene was finished.

The polypropylene produced in the Example was vacuum-dried (70° C., 13.3 kPa, 60 mins), followed by cooling in a desiccator. 2±0.0001 g of the polymer sample was put in a 500 ml flask, to which 200 ml of o-xylene was added. The flask, to which nitrogen and cooling water was connected, was heated for one hour during the reflux of o-xylene. Then, the flask was cooled down in air up to 100° C. for 5 minutes. After the flask was well-shaken, the insoluble was precipitated in a bath maintaining a constant temperature (25±0.5° C.) for 30 minutes. The precipitate was filtered several times using 200 mm No.4 extract paper until it was completely clean. The aluminum pan was dried at 150° C. for 30 minutes, followed by cooling in a desiccator, and its weight was then measured. 100 ml of the filtered o-xylene was added on the aluminum pan using a pipette. The aluminum pan was heated at 145-150° C. to evaporate the o-xylene. Upon impletion of the evaporation, the aluminum pan was vacuum-dried at 70±5° C. for one hour up to 13.3 kP. After cooling in a desiccator, the weight was measured twice (Error was less than 0.0002 g).

The portion (weight %) of the polymer dissolved in o-xylene (Xs) was calculated by the following mathematical formula and the weight of a non-extracted polymer in o-xylene (100-Xs) was obtained by the value of Xs.

$$Xs = ( \frac{Vbo}{Vb 1} \times ( W 2 - W 1 ) - \frac{Vbo}{Vb 2} \times B ) / Wo \times 100$$

Xs=polymer dissolved in o-xylene, weight %

Vbo (mL)=volume of the initial o-xylene (=200 ml)

Vb1 (mL)=volume of the polymer dissolved in o-xylene (=100 ml)

Vb2 (mL)=volume of the o-xylene obtained for blank test, mL (=100 ml)

W2(g)=sum of the weight of the aluminum pan and the weight of the polymer remaining on the aluminum pan after evaporating o-xylene

W1(g)=weight of the aluminum pan

Wo(g)=weight of the initial polymer (=2 g)

B(g)=average weight of the residue on the aluminum pan in blank test

XI (weight ratio of the non-extracted polymer with o-xylene)=100 ? XS

(4) Haze (Transparency)

Haze was determined according to ASTM D-1003.

(5) Ethylene Content

Ethylene content was determined by using FT-IR (Bio-Rad FTS 3000).

TABLE 1

| | Prepolymerization condition | | | | | | | | | |
|---|---|---|---|---|---|---|---|---|---|---|
| | | Amount | | | | | | | | |
| | | added | | | | | | | | |
| | | of | | | | | | | | |
| | | external | | | | Polymerization result | | | | |
| | External | electron | Order of adding | | | Activity | | Tacti | Ethylene | |
| | electron | donor | monomer | | | (kgPP/ | MFR | city | content | Haze |
| | donor | (mmol) | 1 | 2 | 3 | gCat) | (g/10 min.) | (%) | (wt %) | (%) |
| Example 1 | TMMS | 1.75 | propylene | VCH | — | 38.7 | 4.0 | 95.0 | 2.98 | 25.5 |
| Example 2 | TMMS | 2.63 | propylene | VCH | — | 41.6 | 4.2 | 94.9 | 2.95 | 27.0 |
| Example 3 | TMMS | 4.38 | propylene | VCH | — | 24.6 | 3.5 | 91.4 | 3.67 | 25.1 |
| Example 4 | TMES | 1.75 | propylene | VCH | — | 24.8 | 4.7 | 91.9 | 3.71 | 0.42 |
| Comparative | — | | | | | 32.5 | 4.3 | 94.9 | 3.17 | 73.1 |
| Example 1 | | | | | | | | | | |
| Comparative | — | — | propylene | VCH | | 32.0 | 4.0 | 93.6 | 3.79 | 27.8 |
| Example 2 | | | | | | | | | | |
| Comparative | TMMS | 1.75 | propylene | VCH | propylene | 28.6 | 8.2 | 91.5 | 3.87 | 35.4 |
| Example 3 | | | | | | | | | | |

As shown in table 1, in comparison with polymerization catalysts prepared using a prepolymer comprising an external electron donor according to the Examples of the present invention (Examples 1 and 2) and free from the external electron donor (Comparative Example 2), the activity of the polymerization catalyst is increased with the amount added of the external electron donor. However, on the contrary an excess amount of the external electron donor (Example 3) decreases the activity of the polymerization catalyst than that of the polymerization catalyst free from the external electron donor (Comparative Example 2). The transparency of the polymerization catalyst, which is one of significant properties for polypropylene, according to the Example 3 is merely better than that of the catalyst of the Comparative Example 2. As indicated in the above, it is confirmed that a small amount of trimethylmethoxysilane has an effect of improving the activity and the transparency; however an excess amount of trimethylmethoxysilane effect adversely. This is because a small amount of the external electron donor plays a role in increasing active sites of the catalyst having a tacticity, whereas an excess amount thereof causes the catalyst to prevent the active sites.

In addition, from the examples of the present invention is it confirmed that the addition of an external electron donor followed by the prepolymerization (Example 1) has more excellent catalyst activity, haze and tacticity than a method in which the external electron donor is added on the prepolymerization and vinyl cyclic saturated hydrocarbon is prepolymerized and then propylene is prepolymerized (Comparative Example 3). This is because the method of Comparative Example 3 decreases the catalyst active sites and a crystal constituting of vinyl cyclohexane polymer does not play a proper role of a nucleating agent.

Further, a polypropylene prepared by using trimethylmethoxysilane (Example 1) and trimethylethoxysilane (Example 4) as an external electron donor according the present invention has excellent transparency. The polypropylene prepared by using trimethylmethoxysilane (Example 1) as an external electron donor has more excellent activity and tacticity because the external electron donor having methoxy group less bulky than ethoxy group is more effective for improving the catalyst activity.

### INDUSTRIAL APPLICABILITY

A polypropylene prepared by the method of the present invention exhibited excellent tacticity and transparency and the activity of the polymerization catalyst is not decreased at the polymerization of propylene.

1. A method of preparing a highly transparent polypropylene comprising a step of prepolymerizing an α-olefin and a vinyl cyclic saturated hydrocarbon in the presence of a Ziegler-Natta catalyst and an external electron donor, wherein a step of adding and prepolymerizing the α-olefin is followed by a step of adding and prepolymerizing the vinyl cyclic saturated hydrocarbon.

2. The method of preparing a highly transparent polypropylene according to claim 1, wherein the α-olefin is propylene.

3. The method of preparing a highly transparent polypropylene according to claim 1, wherein the molar ratio of the external electron donor to a transition metal compound included in the Ziegler-Natta catalyst is 0.1-10.

4. The method of preparing a highly transparent polypropylene according to claim 1, wherein the external electron donor comprises one or more functional group selected from the group consisting of substituted or unsubstituted alkyl having 1 to 20 carbon atoms, substituted or unsubstituted aryl having 6 to 30 carbon atoms, substituted or unsubstituted cycloalkyl having 5 to 30 carbon atoms, and substituted or unsubstituted alkoxy group having 1 to 20 carbon atoms; and an organic silane compound having at least one oxygen atoms.

5. The method of preparing a highly transparent polypropylene according to claim 1, wherein the external electron donor is an aromatic organic silane compound, aliphatic organic silane compound or a mixture thereof.

6. The method of preparing a highly transparent polypropylene according to claim 1, wherein the external electron donor is selected from a group consisting of diphenyldimethoxysilane, phenyltrimethoxysilane, phenylethyldimethoxysilane, phenylmethyldimethoxysilane, trimethylmethoxysilane, isobutyltrimethoxysilane, diisobutyldimethoxysilane, diisopropyldimethoxysilane, di-t-butyldimethoxysilane, dicyclopentyldimethoxysilane, cyclohexylmethyldimethoxysilane, dicyclohexyldimethoxysilane, and a mixture thereof.

7. The method of preparing a highly transparent polypropylene according to claim 1, wherein the α-olefin is added to the prepolymerization process at 0.5-20 g/g Ziegler-Natta catalyst (containing 0.50 mmol of titanium).

8. The method of preparing a highly transparent polypropylene according to claim 1, wherein the vinyl cyclic saturated hydrocarbon is selected from the group consisting of vinyl cyclobutane, vinyl cyclopentane, vinyl cyclohexane, vinyl-3-methylcyclopentane, vinyl-2-methylcyclohexane, vinyl-3-methylcyclohexane, and a mixture thereof.

9. The method of preparing a highly transparent polypropylene according to claim 1, wherein the vinyl cyclic saturated hydrocarbon is added at 10-30 g/g Ziegler-Natta catalyst (containing 0.50 mmol of titanium).

10. The method of preparing a highly transparent polypropylene according to claim 1, wherein the Ziegler-Natta catalyst is prepared by using a transition metal (Impound comprising elements of family 4, family 5 or family 6 of the periodic table; and an organic metal compound comprising elements of family 13 of the periodic table.

11. The method of preparing a highly transparent polypropylene according to claim 10, wherein the molar ratio of the organic metal compound to the transition metal compound is 5-50.

12. The method of preparing a highly transparent polypropylene according to claim 10, the transition metal compound is a solid titanium catalyst containing magnesium, titanium, a halogen element and an internal electron donor.

13. The method of preparing a highly transparent polypropylene according to claim 10, the organic metal compound is an organic aluminum compound.

14. The method of preparing a highly transparent polypropylene according to claim 10, the organic metal compound is selected from a group consisting of a trialkyl aluminum, a dialkyl aluminum halide, an alkyl aluminum dihalide, an aluminum dialkyl hydride, an alkyl aluminum sesquihalide, and a mixture thereof.

15. The method of preparing a highly transparent polypropylene according to claim 10, the organic metal compound is one or more selected from a group consisting of Al(C₂H₅)₃, Al(C₂H₅)₂H, Al(C₃H₇)₃H, Al(C₃H₇)₂H, Al(i-C₄H₉)₂H, Al(C₈H₁₇)₃, Al(C₁₂H₂₅)₃, Al(C₂H₅)(C₁₂H₂₅)₂, Al(i-C₄H₉)(C₁₂H₂₅)₂, Al(i-C₄H₉)₃, (C₂H₅)₂AlCl, (i-C₃H₇)₂AlCl, and (C₂H₅)₃Al₂Cl₃.

16. The method of preparing a highly transparent polypropylene according to claim 10, wherein the organic metal compound is selected from a group consisting of a mixture of Al(C₂H₅)₃ and Al(i-C₄H₉)₃; a mixture of Al(C₂H₅)₃ and Al(C₈H₁₇)₃; a mixture of Al(C₄H₉)₂H and Al(C₈H₁₇)₃; a mixture of Al(i-C₄H₉)₃ and Al(C₈H₁₇)₃; a mixture of Al(C₂H₅)₃ and Al(C₁₂H₂₅)₃; a mixture of Al(i-C₄H₉)₃ and Al(C₁₂H₂₅)₃; a mixture of Al(C₂H₅)₃ and Al(C₁₆H₃₃)₃; and a mixture of Al(C₃H₇)₃ and Al(C₁₈H₃₇)₂(i-C₄H₉).
